(19) United States
(12) Patent Application Publication
(10) Pub. No.: US 2002/0082889 A1
(43) Pub. Date: Jun. 27, 2002

(54) System and method for project management and assessment

(75) Inventor: Michael E. Oliver, Etters, PA (US)

Correspondence Address: David G. Wille, Baker Botts, L.L.P., 2001 Ross Avenue, Dallas, TX, 75201-2980, US

(73) Assignee: ELECTRONIC DATA SYSTEMS CORPORATION

(21) Appl. No.: 09/742,626

(22) Filed: Dec. 20, 2000

(51) Int. Cl. G06F 17/60

(52) U.S. Cl. 705/8

(57) ABSTRACT

The present invention provides a system (100) for monitoring and assessing the performance of a project, which system includes a computer (120) and a software program associated with the computer (120), with the software program and computer (120) operable in combination to receive project task data and earned value information from a project management software file, determine schedule recovery date information, and graphically displaying the schedule recovery date information. The present invention also provides a method for monitoring and assessing the performance of a project, which method includes obtaining the task data and earned value information from a project management software file; determining schedule recovery date information; and displaying schedule recovery date information.

### TECHNICAL FIELD OF THE INVENTION

The invention relates to project management systems and methods, and more particularly to a software-based system and method for project management and assessment.

### BACKGROUND OF THE INVENTION

Good project management is an important factor to the success of a project. A project may be thought of as a collection of activities and tasks designed to achieve a specific goal of the organization, with specific performance or quality requirements while meeting any applicable time and cost constraints. Project management refers to managing the activities that lead to the successful completion of a project. Project management focuses on finite deadlines and objectives. A number of tools may be used to assist with project management and assessment.

A fundamental scheduling technique used in project management is the Critical Path Method (CPM). With this model, the tasks that must be completed are determined and task data developed for each. The task data may include the start date, time required, sequencing requirements, finish date, cost effort, and resources. When all the tasks are determined, the path of tasks on the longest sequence for completion of the project becomes what is known as the “critical path” and the tasks on it “critical tasks.” The sequencing of tasks in the project may be graphically presented in what is known as a PERT chart. The tasks and their duration may also be presented with a bar chart known as a Gantt chart.

A typical large project may be thought of as having four phases: (a) start up, (b) planning, (c) execution, and (d) close-down. During the planning phase, the numerous tasks that make up the project are determined and task data for each are determined. A baseline may be established when all of the project stakeholders concur on the appropriate plan. The baseline is the approved project plan (amount and timing) for a work assignment, output, set of outputs, or overall project. As used herein, cost is an all-inclusive term that includes either dollars or effort hours. The baseline represents cost and effort expenditures with respect to time and activities. The resources necessary to complete project activities provide the basis for determining the cost and effort requirements. This determination is initially performed in the project planning stage and revisited whenever baseline revisions are deemed necessary.

The baseline is referenced throughout the project with the actual data. The actual data refers to the start and finish dates for tasks and actual costs, e.g., actual effort hours, applied or spent on a work assignment, output, set of outputs, or the overall project. At periodic time intervals during the project, the actuals and baseline are compared to determine any variance from the plan and also to forecast anticipated completion dates and costs for all remaining work. The forecast is the predicted cost, e.g., effort hours, to be spent to complete the remainder of a work assignment, output, set of outputs, or the overall project.

Many project schedule management software (collectively “project management software”) are commercially available, such as Microsoft® Project, which comes in numerous versions such as Microsoft® Project for Windows® 95. Such software allows for task data, such as duration, start date, finish date, and resources, to be entered. As the project advances, information on actual performance may be entered and information developed and presented concerning the performance of the project to date. See generally, Tim Pyron and Kathryne Valentine, Using Microsoft® Project for Windows® 95 (special ed. 1996).

Certain project management software can also provide earned value (EV) analysis information. In managing a project, earned value (EV) analysis is applied to provide an objective measurement of a project's cost and schedule performance, thereby facilitating objective analysis of the project's cost and schedule. For example, by comparing earned value with a baseline, the value of the work accomplished is compared to the value of the work planned. By comparing earned value and actuals, the value of work accomplished is compared to the value of the costs actually spent.

However, these project management software do not provide sufficient or readily accessible information to determine schedule recovery date (SRD) information, i.e., the anticipated date at which a schedule variance may be recovered and associated information. During the execution period of a typical large project, as discussed above, the project may fall behind the baseline schedule, thereby creating a schedule variance (SV), i.e., when the cumulative budgeted cost of work performed (BCWP) is less than the cumulative budgeted cost of work scheduled (BCWS). Accordingly, schedule recovery date information can readily provide valuable insight to many management questions, such as “How much over time is required to recover the schedule variance, and by what date will the schedule variance be recovered?”

### SUMMARY OF THE INVENTION

Therefore, a need exists for a software-based system and method for project management and assessment that provides detailed schedule recovery date (SRD) information.

In accordance with one aspect of the present invention, a system is provided for monitoring and assessing the performance of a project. The system includes a computer and a software program associated with the computer, the software program and computer operable in combination to: (1) receive project task data and earned value information from a project management software file or a historical data file; (2) determine schedule recovery date (SRD) information from the project task data and earned value information; and (3) display the schedule recovery date information (SRD). SRD information can include SRD related information. The software program and computer can also be operable to determine the SRD information by accessing a historical data file.

In accordance with another aspect of the present invention, a method is provided for monitoring and assessing the performance of a project. The method includes: (1) receiving project task data and earned value information from a project management software file or a historical data file; (2) determining schedule recovery date (SRD) information from the project task data and earned value information; and displaying the schedule recovery date (SRD) information.

In another aspect of the present invention, the system or method further includes displaying messages to explain information selected from the group consisting of proposed courses of action, significance of SRD information in comparison to other project information, and combinations thereof. These explanatory messages can be provided in response to a project manager's request.

In still another aspect of present invention, the SRD information is obtained by the system or method by the following: (1) calculating the total over time effort hours required; (2) calculating the total over time effort hours available for a successive reporting period following the current reporting date (CRD); and (3) setting the schedule recovery date equal to the reporting period is the total over time effort hours available is equal to or greater than the total over time effort hours required; wherein at least the last two steps are repeated for each successive reporting period until a schedule recovery date, at which the total over time effort hours available is equal to or greater than the total over time effort hours required, is determined or until a project baseline finish date is reached.

### BRIEF DESCRIPTION OF THE DRAWINGS

For a more complete understanding of the present invention and advantages thereof, reference is now made to the following description taken in conjunction with the accompanying drawings in which like reference numerals indicate like features and wherein:

FIG. 1 is a graph of baseline effort hours and full time equivalent staff count for an exemplary project with which the present invention may be utilized;

FIG. 2 is an exemplary graphical display of cumulative project task data, cumulative earned value analysis information, and cumulative available over time information for a project according to the present invention;

FIG. 3 is a perspective view of an exemplary system in accordance with the present invention;

FIG. 4 is a block diagram of an exemplary architecture of software that can be used in the system of FIG. 3; and

FIGS. 5A and 5B are flowcharts illustrating one exemplary process flow for a method according to the present invention.

### DETAILED DESCRIPTION OF THE INVENTION

Preferred embodiments of the present invention are illustrated in FIGS. 1-5 of the drawings, like numerals being used for like and corresponding parts of the various drawings.

Schedule recovery date (SRD) information and related analysis provide an objective forecast of an anticipated date when a project's schedule variance can be recovered through the utilization of over time effort hours using existing staff. Accordingly, SRD information and related analysis provide an advantage when there is a schedule variance, i.e., when the cumulative budgeted cost of work performed (BCWP) is less than the cumulative budgeted cost of work scheduled (BCWS). A project manager having this information can then have sufficient lead time to plan ahead and secure additional over time hours for the project.

SRD information and related analysis information can be obtained from task data (e.g., such as, duration, start date, finish date, and allocated resources) and earned value (EV) information and EV-related information. EV information and EV-related information are well known to the skilled artisan, as described in U.S. Pat. No. 5,907,490 issued May 25, 1999 to Oliver, which is incorporated herein by reference in its entirety.

A simple example will illustrate the need for SRD information and related analysis information. Referring to FIG. 1, a baseline graph of efforts hours and full time equivalent staff count for an exemplary project with which the present invention may be utilized is shown. The abscissa axis 10 reflects reporting time increments in weeks. The ordinate axis 12 shows the effort hours or full time equivalent staff count on a logarithmic scale. The scheduled project resources for a particular week is illustrated by line 14; the available over time hours for a particular week are provided by line 16; and line 18 provides the scheduled full time equivalent staff count for a particular week. For simplicity, the scheduled project resources assumes 6 hours per day for each full time equivalent (FTE) and a reasonable over time rate (OTrate) of 2 hours per day for each full time equivalent. As used herein, full time equivalent (FTE) represents a typical staff member; full time equivalent rate (FTEᵣₐₜₑ) means the number of effort hours a typical staff member can contribute in a particular time period, e.g., a day; and over time rate (OTᵣₐₜₑ) is the reasonable number of over time effort hours that can be contributed by the same staff member. Note that FTE, FTEᵣₐₜₑ, and OTᵣₐₜₑ are variables that are typically set at the planning stage but can later be altered by the project manager to evaluate alternative schedule recovery scenarios.

In week 1, therefore, two staff members (FTE's) are scheduled to provide 60 effort hours at a FTEᵣₐₜₑ of 30 hours per week or 6 hours per day. Furthermore, the two staff members are also available to provide, on a need basis, an additional 20 over time effort hours at an OTᵣₐₜₑ of 10 hours per week or 2 hours per day. The scheduling shown in the chart of FIG. 1 is typically done in the planning process, and as scheduled, constitutes the baseline for the project. This information can also be saved in a project task data file.

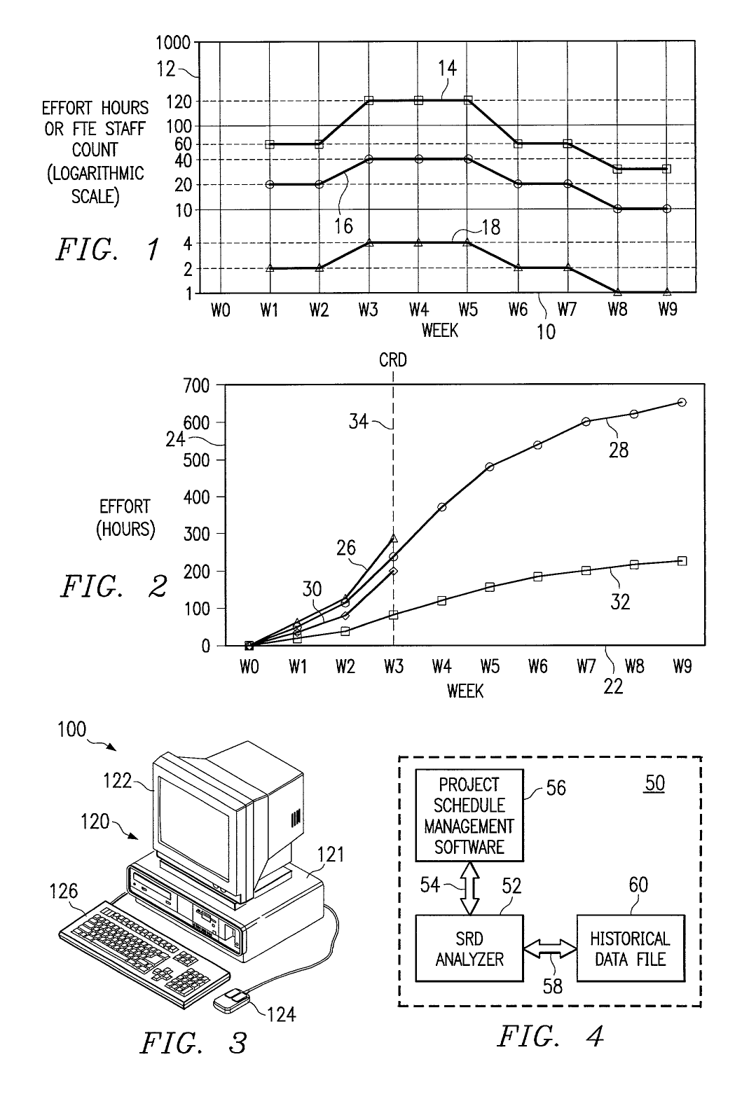

Referring now to FIG. 2, an exemplary graphical display is provided to illustrate project task data, EV analysis information, actual information, and available over time information for a project according to the present invention. The baseline task data for the delivery of effort hours and available overtime hours shown in the graph can be based on exemplary information from FIG. 1. The graph has on its abscissa axis 22 the reporting time increments in weeks. Note that the reporting time increments can be changed to any appropriate time period, e.g., each day, each month, each quarter or each year. The ordinate axis 24 shows the effort hours for the project.

The baseline cumulative effort hours obtained from the project task data is graphically illustrated by line 28. This baseline is called the cumulative budget cost of work scheduled curve (cumulative BCWS), which can be derived from the work scheduled in FIG. 1. The cumulative available over time effort hours, which is one type of information provided by the present invention, is represented by line 32. The actual effort hours expended is represented by the cumulative actual cost of work performed curve (cumulative ACWP), which is illustrated by line 26. The earned value information is represented by the cumulative budget cost of work performed curve (cumulative BCWP), which is illustrated by line 30.

FIG. 2 provides additional important information. For example, at the current reporting date (CRD) 34, e.g., at the end of week 3, 240 effort hours of earned value were scheduled to be completed through the CRD, as illustrated by line 28. According to FIG. 2, however, only 200 hours of earned value were delivered by the CRD, as described by line 30. The project is, therefore, behind schedule. Furthermore, the project is also over budget, because the earned value delivered by the CRD had an actual cost of 290 effort hours, as described by line 26. As a result, at the end of week 3, the project has a schedule variance (cumulative BCWP minus cumulative BCWS) of 40 hours and a cost variance of 90 effort hours (cumulative BCWP minus cumulative ACWP). The over time effort hours necessary to recover the schedule variance may be stated as |SV{cube root}÷CPI, i.e., 57.97 effort hours, wherein the cost performance index (CPI) equals BCWP÷ACWP, i.e., 0.69.

A quick inspection of the potential over time hours described by line 32 reveals that, starting from the CRD, 40 effort hours of over time are available to the project by the end of week 4 (e.g., 120 hours at week 5 minus 80 hours at the CRD). Using the same approach, all of the over time effort hours required to recover the schedule variance will be available by Wednesday of week 5. Therefore, the schedule recovery date (SRD) is Wednesday of week 5.

This simple example shows the importance of objectively tracking the actual cost of completed tasks during project management by utilizing scheduled, actual, and EV information. SRD analysis and the information resulting therefrom are valuable to a project manager for determining whether the schedule variance (SV) is recoverable, by when and at what cost. SRD analysis can, therefore, be used to develop plans to recover the SV and to ascertain that the recovery of SV is occurring according to one or more of the selected plans. Typically, SRD analysis is most helpful when there is a schedule variance at any current reporting date (CRD), i.e., when cumulative BCWS is greater than cumulative BCWP at a given reporting date.

Referring to FIG. 3, a perspective view of an exemplary system in accordance with the present invention is shown. Exemplary system 100 for project management and assessment includes a microprocessor-based computer 120. Computer 120 preferably has an Intel 80×86 microprocessor, such as an 80486 or Pentium that may be housed in a main computer portion 121. Computer 120 is preferably capable of running Microsoft Windows® Version 3.1 or higher and Microsoft® Project (MP) or other project management software. Computer 120 will typically include components, such as an internal hard drive or other suitable program memory, and/or one or more disc drives for uploading programs and data. Computer 120 may also include other devices, such as CD ROM drives, optical drives and/or other devices. Computer 120 includes a sufficient amount of memory to support its operating system as well as all applications and utility software desired to run on computer 120.

Computer 120 further includes a display screen 122, which may have a graphical user interface (GUI). Computer 120 may receive input from a touch screen; a pointing device 124, which may be any of a number of devices, such as a mouse, a touch pad, a roller ball, or other devices; and may also receive input through keyboard 126. Computer 120 is further programmable and operable to perform SRD analysis according to the system and methods of the present invention. The programming of computer 120 to carry out the steps discussed herein, may be accomplished with any number of computers and any number of programming languages or applications (e.g., BASIC, VISUAL BASIC, FORTRAN, PASCAL, AND COBAL), but in a preferred embodiment, is programmed using Microsoft®'s VISUAL BASIC.

Referring now to FIG. 4, a block diagram of an exemplary architecture 50 for software that can be used within the system of FIG. 3 is shown. As an important aspect of the present invention, a software module or programming segment 52 is used to calculate and display SRD information and SRD-related information. As used herein, SRD information means the schedule recovery date, and SRD-related information means any information relating to the schedule recovery date, which can include, but is not limited to, EV information for any past reporting period, projected EV information for any future reporting period, statistical EV information, statistical schedule recovery date information derived from statistical EV information, available total over time effort hours and related date information, total over time effort hours required, and costs associated with the over time effort hours.

Module or segment 52 will be referred to as a “SRD analyzer” 52. An object link 54 is established between the SRD analyzer 52 and the project management software 56; which software 56, by way of example, is shown as Microsoft Project®, with one or more data files. For example, object link 54, which may be an object link (OLE2) in Microsoft® VISUAL BASIC, allows information, such as task data, to be delivered upon request to SRD analyzer 52. SRD analyzer 52 may also receive information by a data link 58 from a historical data file 60, which can contain appropriate historical data, such as project task data, EV information, and EV-related information. File 60 may be a floppy disk or hard disk or other storage medium accessible to SRD analyzer 52 on computer 120.

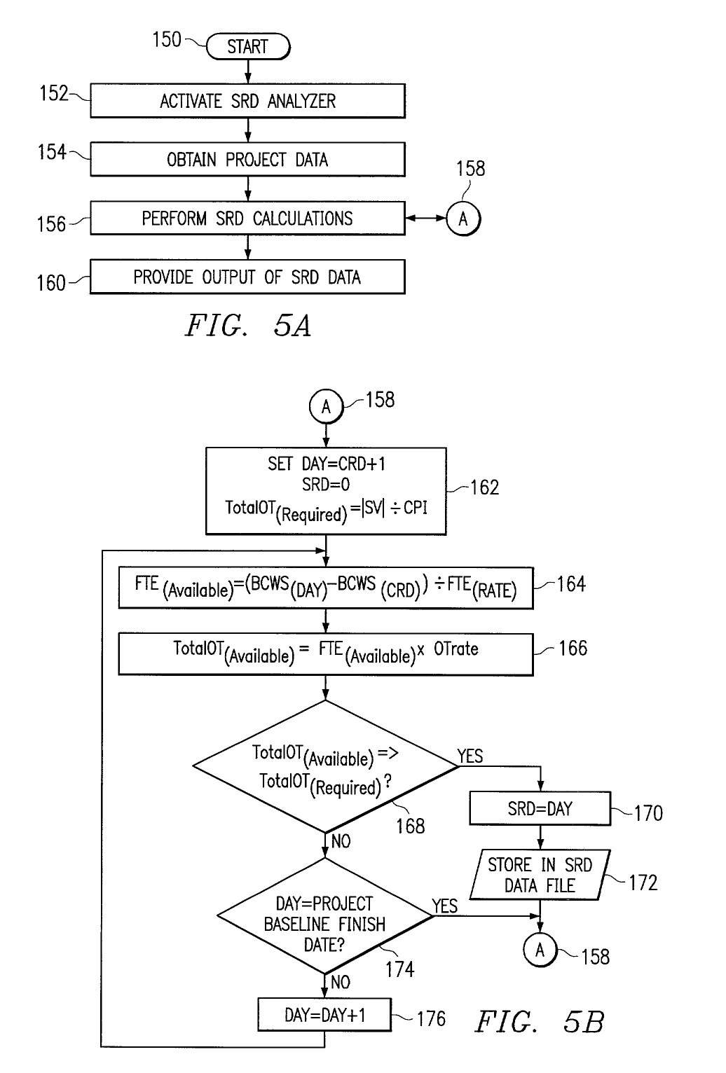

Referring now to FIGS. 5A and 5B, a flowchart illustrating one exemplary process flow for a method according to the present invention is shown. The basic events are presented and then described in more detail further below. The process is accomplished with architecture 50 (FIG. 4) described above as part of system 100 (FIG. 3). After starting at block 150, the first step is for the SRD analyzer to be activated, as shown in block 152. The SRD analyzer can be activated, for example, when there is a schedule variance. Then, a specific project schedule file or historical data file is opened to obtain the project task data and EV data at the current reporting date (CRD), as shown at block 154 from the project schedule management software or the historical data file. For example, the EV data can include the following data calculated at the current reporting date: the cumulative BCWP; the cumulative BCWS; the cumulative ACWP; the cumulative schedule performance index (SPI), which is the cumulative BCWP divided by the cumulative BCWS; and the cumulative cost performance index (CPI), which is the cumulative BCWP divided by the cumulative ACWP. The SRD analyzer program segment is then initiated to perform the SRD calculations, as shown at blocks 156 and 158. Once initiated, current SRD information is calculated by the SRD analyzer, as shown in blocks 158 to 176. The SRD information can then be provided in any desired output format, e.g., in a graphic, table, and/or explanatory report format, as shown at block 160.

Once the SRD analyzer is activated, as illustrated in FIG. 5B, the variable DAY is set to the desired reporting period, and the variable SRD is initialized, e.g., set to zero, as shown in block 162. Note that the reporting period can be chosen to be any desired period, such as for example, a day, a week, a month, a quarter, a year, and a decade. Also in this step, the absolute value of the schedule variance is used, because most project management software define schedule variance as cumulative BCWP minus cumulative BCWS. Preferably, the absolute value of the schedule variance can be divided by the cumulative cost performance index (CPI) to obtain a more accurate estimate of the total over time effort hours needed based on past performance, as also shown in block 162.

Next the number of full time equivalents available (FTE_{(Available)}) through the reporting period being analyzed (e.g., a successive reporting period after the CRD, such as the next day, week, or year) is obtained. This can be done, for example, by (1) obtaining the difference between the cumulative BCWS for the reporting period being analyzed and the cumulative BCWS for the current reporting date, and (2) dividing the difference by the hours per day available from each full time equivalent (FTE₍ᵣₐₜₑ₎), as illustrated in block 164. Alternatively, the number of full time equivalents available through the reporting period being analyzed can be obtained from the project task data file, e.g., by adding the number of full time equivalents scheduled in the baseline project task data for each reporting period between the current reporting date and the reporting period being analyzed. For example, the information provided in line 18 of FIG. 1 can be used to add the number of full time equivalents for each day from the current reporting date to the reporting date being analyzed.

The total over time effort hours available (TotalOT_{(Available)}) for the reporting period being analyzed is then calculated by multiplying the full time equivalents available (FTE_{(Available)}) by the reasonable over time rate per day for each full time equivalent (OTrate), as illustrated by block 166. If the total over time effort hours available (TotalOT_{(Available)}) is equal to or greater than the total over time effort hours required (TotalOT_{(Required)}), the variable SRD is set equal to the variable DAY, as shown in blocks 170 and 172. Otherwise, the process illustrated in blocks 164 to 168 is repeated for each successive reporting period (e.g., the next day), as illustrated by blocks 174 and 176, until either (a) the total over time effort hours available is equal to or greater than the total over time effort hours required, or (b) the variable DAY is equal to the project baseline finish date, which signals that the SV cannot be recovered with existing staff members. Note that all of the information obtained for a particular reporting period can be saved to a data file and/or displayed in any desired format after the completion of each iteration.

In another embodiment of the present invention, the amount of schedule variance which should be recovered for a particular future period can be further provided. For example, a project manager may want to know how much of the schedule variance should be recovered by the end of each week, e.g., on every Friday. This can be done by adding a decision block to the present process flow of FIG. 5B in between blocks 168 and 174 or in between blocks 174 and 176. Such a decision block can provide a schedule variance recovered through this period, e.g., every Friday, by setting a variable, such as SV_{RecoveredThroughThisDate}, equal to the total over time effort hours available (TotalOT_{(Available)}) when the variable DAY is equal to a specific day or reporting period, e.g., every Friday or every two weeks. The schedule variance recovered and the corresponding date can then be stored in the SRD data file to be later used in any desired output format.

The information in the SRD data file obtained from the SRD analyzer can then be presented in a graph or in a report. Using this data, a project manager can effectively and objectively determine the additional amount of over time effort hours needed to recover the schedule variance (SV) with existing staff members, the date by which the SV may be recovered, a SV recovery schedule, and the corresponding cost of recovering the SV.

In another embodiment of the present invention, advisory messages can be provided to explain the schedule recovery date information. Such advisory messages can be automatically provided or provided at the request of the project manager. Advisory messages that can be provided include, but are not limited to, explanatory information, proposed courses of action, and evaluations thereof. Explanatory information provides the project manager with insight about the significance of the SRD information in relationship to other project environment variables. For example, explanatory information can include an explanation of the probability for successful schedule variance recovery given the duration of the over time necessary to recover the variance as indicated by the SRD and the known effects of sustained over time on team productivity. Evaluations of proposed courses of action include providing the cost trade-offs of over time versus penalties for late delivery.

Although the present invention and its advantages have been described in detail, it should be understood that various changes, substitutions, and alterations can be made therein without departing from the spirit and scope of the invention as defined by the appended claims.

What is claimed is:

1. A system for monitoring and assessing the performance of a project, the system comprising:
a computer; and
a software program associated with the computer, the software program and computer operable in combination to:
receive project task data and earned value information from a project management software file or a historical data file;
determine schedule recovery date (SRD) information from the project task data and earned value information; and
display the schedule recovery date (SRD) information.

2. The system of claim 1, wherein the SRD information includes SRD related information.

3. The system of claim 2, wherein the software program and computer are operable to determine the SRD information by accessing a historical data file.

4. The system of claim 1, further comprising displaying advisory messages selected from the group consisting of proposed courses of action, explanatory information, and combinations thereof.

5. The system of claim 1, wherein the software program and computer are operable to obtain the SRD information by:
calculating the total over time effort hours required;
calculating the total over time effort hours available for a successive reporting period following the current reporting date (CRD); and
setting the schedule recovery date equal to the reporting period is the total over time effort hours available is equal to or greater than the total over time effort hours required;
wherein at least the last two steps are repeated for each successive reporting period until a schedule recovery date, at which the total over time effort hours available is equal to or greater than the total over time effort hours required, is determined or until a project baseline finish date is reached.

6. The system of claim 5, wherein at least the last two steps are repeated for each successive reporting period until a project baseline finish date is reached.

7. The system of claim 5, wherein the total over time effort hours required is calculated by setting it equal to the absolute value of the schedule variance.

8. The system of claim 5, wherein the total over time effort hours required is calculated by dividing the absolute value of the schedule variance by the cost performance index (CPI).

9. The system of claim 5, wherein the total over time effort hours available is calculated by multiplying a total number of available full time equivalents from the current reporting date to the reporting period being analyzed by a reasonable over time rate per day for each available full time equivalent.

10. The system of claim 9, wherein the total number of available full time equivalents is calculated by obtaining the difference between the cumulative budget cost of work scheduled (BCWS) for the reporting period being analyzed and the cumulative budget cost of work scheduled (BCWS) for the current reporting date, and dividing the difference by the hours per day available from each full time equivalent.

11. The system of claim 9, wherein the total number of available full time equivalents is calculated by adding the number of full time equivalents scheduled for each reporting period from the current reporting date to the reporting period being analyzed.

12. The system of claim 5, wherein the reporting period is selected from the group consisting of a day, a week, a month, a quarter, a year, and a decade.

13. The system of claim 5, further comprising storing in a data file information selected from the group consisting of the schedule recovery date, the total over time effort hours available for each reporting period, the corresponding reporting period being analyzed, and combinations thereof.

14. A method of monitoring and assessing the performance of a project, comprising:
receiving project task data and earned value information from a project management software file or a historical data file;
determining schedule recovery date (SRD) information from the project task data and earned value information; and
displaying the schedule recovery date (SRD) information.

15. The method of claim 14, further comprising displaying advisory messages selected from the group consisting of proposed courses of action, explanatory information, and combinations thereof.

16. The method of claim 14, wherein the SRD information is obtained by:
calculating the total over time effort hours required;
calculating the total over time effort hours available for a successive reporting period following the current reporting date (CRD); and
setting the schedule recovery date equal to the reporting period if the total over time effort hours available is equal to or greater than the total over time effort hours required;
wherein at least the last two steps are repeated for each successive reporting period until a schedule recovery date, at which the total over time effort hours available is equal to or greater than the total over time effort hours required, is determined or until a project baseline finish date is reached.

17. The method of claim 16, wherein at least the last two steps are repeated for each successive reporting period until a project baseline finish date is reached.

18. The method of claim 16, wherein the total over time effort hours required is calculated by setting it equal to the absolute value of the schedule variance.

19. The method of claim 16, wherein the total over time effort hours required is calculated by dividing the absolute value of the schedule variance by the cost performance index (CPI).

20. The method of claim 16, wherein the total over time effort hours available is calculated by multiplying a total number of available full time equivalents from the current reporting date to the reporting period being analyzed by a reasonable over time rate per day for each available full time equivalent.

21. The method of claim 20, wherein the total number of available full time equivalents is calculated by obtaining the difference between the cumulative budget cost of work scheduled (BCWS) for the reporting period being analyzed and the cumulative budget cost of work scheduled (BCWS) for the current reporting date, and dividing the difference by the hours per day available from each full time equivalent.

22. The method of claim 20, wherein the total number of available full time equivalents is calculated by adding the number of the number of full time equivalents scheduled for each reporting period from the current reporting date to the reporting period being analyzed.

23. The method of claim 16, wherein the reporting period is selected from the group consisting of a day, a week, a month, a quarter, a year, and a decade.

24. The method of claim 16, further comprising storing in a data file information selected from the group consisting of the schedule recovery date, the total over time effort hours available for each reporting period, the corresponding reporting date being analyzed, and combinations thereof.

25. The system of claim 16, further comprising determining and displaying the schedule variance recovered at certain preselected reporting periods and the corresponding reporting periods.
